(19) United States
(12) Patent Application Publication
(10) Pub. No.: US 2016/0246483 A1
(43) Pub. Date: Aug. 25, 2016

(54) DISPLAY CONTROL DEVICE, COMMUNICATION TERMINAL, AND DISPLAY CONTROL METHOD

(71) Applicant: FUJI XEROX CO., LTD., Tokyo (JP)

(72) Inventors: Yusuke KANO, Kanagawa (JP); Kazunori HORIKIRI, Kanagawa (JP)

(21) Appl. No.: 14/809,791

(22) Filed: Jul. 27, 2015

(30) Foreign Application Priority Data
Feb. 23, 2015 (JP) 2015-032823

(51) Int. Cl. G06F 3/0484; G09G 5/00; G06F 3/14; G06F 3/0482

(52) U.S. Cl. CPC G06F 3/04842; G06F 3/0482; G09G 5/005; G06F 3/04845; G06F 3/1454; G09G 2354/00

(57) ABSTRACT

A display control device includes a selection receiver, a first object generator, and a display controller. The selection receiver receives a selection related to a selection of a group with respect to multiple objects displayed on a first display. The first object generator generates a single representative object from the multiple objects selected as the group. The display controller displays the multiple objects selected as the group and the representative object on the first display.

### CROSS-REFERENCE TO RELATED APPLICATIONS

This application is based on and claims priority under 35 USC 119 from Japanese Patent Application No. 2015-032823 filed Feb. 23, 2015.

### BACKGROUND

The present invention relates to a display control device, a communication terminal, and a display control method.

### SUMMARY

According to an aspect of the invention, there is provided a display control device that includes a selection receiver, a first object generator, and a display controller. The selection receiver receives a selection related to a selection of a group with respect to multiple objects displayed on a first display. The first object generator generates a single representative object from the multiple objects selected as the group. The display controller displays the multiple objects selected as the group and the representative object on the first display.

### BRIEF DESCRIPTION OF THE DRAWINGS

Exemplary embodiments of the present invention will be described in detail based on the following figures, wherein:

FIG. 1 is a schematic module configuration diagram for an exemplary configuration according to an exemplary embodiment;

FIG. 2 is an explanatory diagram illustrating an exemplary system configuration utilizing an exemplary embodiment;

FIG. 3 is a flowchart illustrating an exemplary process according to an exemplary embodiment;

FIG. 4 is a flowchart illustrating an exemplary process according to the exemplary embodiment;

FIG. 5 is an explanatory diagram illustrating an exemplary process according to an exemplary embodiment;

FIG. 6 is a flowchart illustrating an exemplary process according to the exemplary embodiment;

FIG. 7 is an explanatory diagram illustrating an exemplary process according to an exemplary embodiment;

FIG. 8 is a flowchart illustrating an exemplary process according to the exemplary embodiment;

FIG. 9 is an explanatory diagram illustrating an exemplary process according to an exemplary embodiment;

FIG. 10 is an explanatory diagram illustrating an exemplary process according to the exemplary embodiment;

FIG. 11 is a flowchart illustrating an exemplary process according to the exemplary embodiment;

FIG. 12 is an explanatory diagram illustrating an exemplary data structure of a sticky-to-sticky distance table;

FIG. 13 is an explanatory diagram illustrating an example arrangement of stickier on a screen;

FIG. 14 is an explanatory diagram illustrating an exemplary process according to an exemplary embodiment;

FIGS. 15A and 15B are explanatory diagrams illustrating an exemplary process according to an exemplary embodiment; and

FIG. 16 is a block diagram illustrating an exemplary hardware configuration of a computer that realizes an exemplary embodiment.

### DETAILED DESCRIPTION

Hereinafter, an exemplary embodiment related to realizing the present invention will be described by way of example on the basis of the drawings.

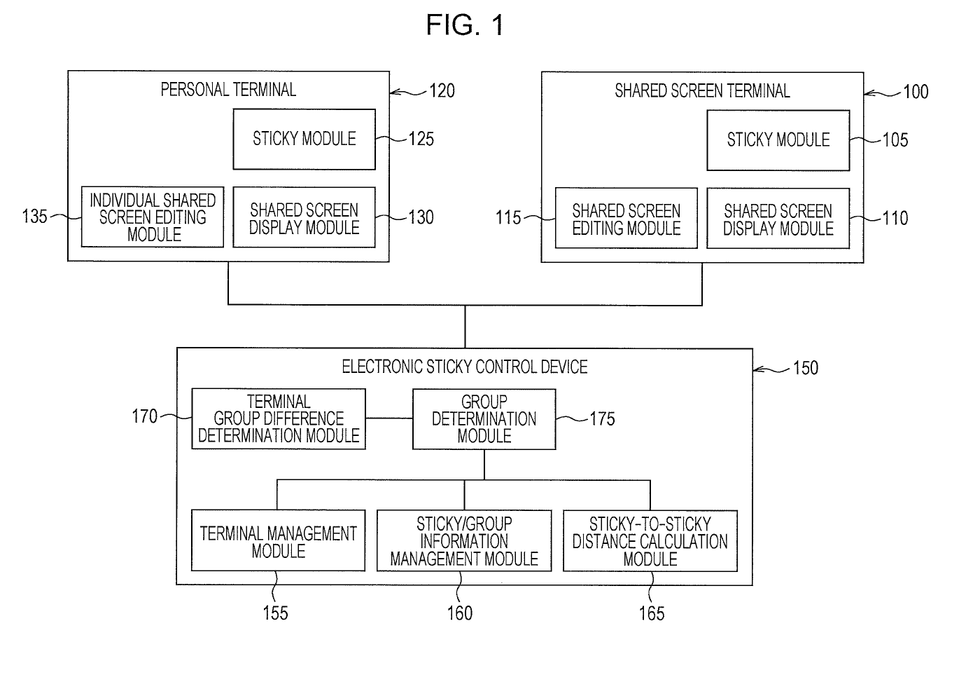

FIG. 1 illustrates a schematic module configuration for an exemplary configuration according to the exemplary embodiment.

Note that the term module refers to components such as software (computer programs) and hardware which are typically capable of being logically separated. Consequently, the term module in the exemplary embodiment not only refers to modules in a computer program, but also to modules in a hardware configuration. Thus, the exemplary embodiment also serves as a description of a computer program (a program that causes a computer to execute respective operations, a program that causes a computer to function as respective units, or a program that causes a computer to realize respective functions), a system, and a method for inducing functionality as such modules. Note that although terms like “store” and “record” and their equivalents may be used in the description for the sake of convenience, these terms mean that a storage device is made to store information or that control is applied to cause a storage device to store information in the case where the exemplary embodiment is a computer program. Also, while modules may be made to correspond with function on a one-to-one basis, some implementations may be configured such that one program constitutes one module, such that one program constitutes multiple modules, or conversely, such that multiple programs constitute one module. Moreover, multiple modules may be executed by one computer, but one module may also be executed by multiple computers in a distributed or parallel computing environment. Note that a single module may also contain other modules. Also, the term “connection” may be used hereinafter to denote logical connections (such as the transfer of data and referential relationships between instructions and data) in addition to physical connections. The term “predetermined” refers to something being determined prior to the processing in question, and obviously denotes something that is determined before a process according to the exemplary embodiment starts, but may also denote something that is determined after a process according to the exemplary embodiment has started but before the processing in question, according to conditions or states at that time, or according to conditions or states up to that time. In the case of multiple “predetermined values”, the predetermined values may be respectively different values, or two or more values (this obviously also includes the case of all values) which are the same. Additionally, statements to the effect of “B is conducted in the case of A” are used to denote that a determination is made regarding whether or not A holds true, and B is conducted in the case where it is determined that A holds true. However, this excludes cases where the determination of whether or not A holds true may be omitted.

Also, the terms “system” and “device” not only encompass configurations in which multiple computers, hardware, or devices are connected by a communication medium such as a network (including connections that support 1-to-1 communication), but also encompass configurations realized by a single computer, hardware, or device. The terms “device” and “system” are used interchangeably. Obviously, the term “system” does not include merely artificially arranged social constructs (social systems).

Also, every time a process is conducted by each module or every time multiple processes are conducted within a module, information to be processed is retrieved from a storage device, and the processing results are written back to the storage device after the processing. Consequently, description of the retrieval from a storage device before processing and the writing back to a storage device after processing may be reduced or omitted in some cases. Note that the storage device herein may include a hard disk, random access memory (RAM), an auxiliary or external storage medium, a storage device accessed via a communication link, and a register or the like inside a central processing unit (CPU).

An electronic sticky control device 150 according to the present exemplary embodiment controls the display of objects and a representative object indicating a group of such objects. As illustrated in FIG. 1, the electronic sticky control device 150 includes a terminal management module 155, a sticky/group information management module 160, a sticky-to-sticky distance calculation module 165, a terminal group difference determination module 170, and a group determination module 175. Also, the electronic sticky control device 150 is connected to a shared screen terminal 100 and a personal terminal 120 via a communication link. Herein, an object refers to an electronic sticky (hereinafter also called a sticky), a card, a document, or the like, for example. In the following description, stickies will be given as an example of objects.

An electronic sticky system improves the efficiency of creating and pasting stickies during work by multiple people compared to working with the paper stickies of the past.

However, even with existing electronic sticky systems, it is difficult for each user to perform the grouping work conducted after pasting stickies during brainstorming, the KJ Method, or the like. Generally, a representative such as a facilitator performs the grouping work on behalf of everyone else.

Also, in the case of grouping performed by assigning different areas to multiple people, which is often conducted when working with paper stickies, new work arises in the merging of the individual areas, and efficiency may not be improved.

The present exemplary embodiment is used when sharing the results of independent grouping performed by participants.

Unlike the case of pasting stickies onto documents, templates, and the like, in which the spatial position of the sticky is meaningful, when pasting stickies onto an electronic whiteboard (a space where electronic stickies are pasted, also called the background or board; hereinafter also referred to as the canvas), the position where a sticky is pasted is not meaningful. Attaching meaning (such as assigning headings to groups, for example) is ordinarily performed afterward.

For this reason, if participants individually attempt to perform grouping on the canvas, groups having the same meaning may appear at different positions. Consequently, merging the position information as-is may be difficult, and if merging is conducted by taking the average of the coordinates or the like, there is even a possibility of losing the original meaning.

Furthermore, assigning attributes (attributes related to groups) at the time of sticky creation is difficult, since ordinarily groups have not been decided at the time of sticky creation or immediately afterward. Also, even if such a process is realized, the usage scenario may become limited with an electronic sticky system.

The shared screen terminal 100 is used by a person such as a facilitator, for example, and is equipped with a display device (shared screen) that may be viewed by multiple users. The display device herein may be a device such as a large-screen liquid crystal display or projector, for example. The display device may also be a PC, notebook PC, tablet, or the like having a communication function, for example. Also, a PC or the like may be built into the display device. Furthermore, the electronic sticky control device 150 may be built into the shared screen terminal 100.

The personal terminal 120 is possessed by an individual user who is a participant, and includes a display device. For example, the personal terminal 120 may be a device such as a notebook PC, a tablet, or a mobile terminal (such as a mobile phone, including a smart phone, for example) having a communication function. On such a display device, when presenting same display as the display device of the shared screen terminal 100, a display enabling the user to perform an operation (for example, an operation such as grouping) may be presented in some cases.

In a system including the shared screen terminal 100, the personal terminal 120, and the electronic sticky control device 150, operable objects (such as stickies, the canvas, and collections of grouped stickies) are shared among multiple users of the shared screen terminal 100 or the personal terminal 120 (including the facilitator). A user who is a participant may move stickies freely on the display screen of the personal terminal 120, separately from the shared screen of the shared screen terminal 100. In other words, multiple users are able to separately operate a sticky, which is one kind of operable object, at different times or on different display screens.

The shared screen terminal 100 typically is used by the facilitator, and includes a sticky module 105, a shared screen display module 110, and a shared screen editing module 115.

The sticky module 105 receives an operation such as the creation, modification, or deletion of a sticky, and conducts a process according to the operation. In some cases, an operation by the facilitator is received on the shared screen terminal 100, and a process related to the creation, modification, or deletion of a sticky is conducted in response to the operation. In other cases, a sticky operation or process result is received on the personal terminal 120, and a process related to the creation, modification, or deletion of a sticky is conducted in response to the operation by the user of the personal terminal 120.

The shared screen editing module 115 receives a move operation on a sticky displayed on the display device of the shared screen terminal 100, and in response to the operation, moves the sticky on the canvas (on the display device).

The shared screen display module 110 displays on the display device stickies created by the sticky module 105. Additionally, the shared screen display module 110 displays the results of processes conducted by the sticky module 105 (such as a modification process or a deletion process). In addition, the shared screen display module 110 modifies the position of stickies according to a move process conducted by the shared screen editing module 115. Additionally, the shared screen display module 110 transmits what is being displayed (which may be information related to data such as the content and attributes of each sticky as well as information related to the display position of each sticky, and may also be data such as a snapshot image of the display device) to the personal terminal 120.

The personal terminal 120 is used by a user who is a participant, and includes a sticky module 125, a shared screen display module 130, and an individual shared screen editing module 135.

The sticky module 125 receives an operation such as the creation, modification, or deletion of a sticky, and conducts a process according to the operation. The sticky module 125 may also be transmit the process result to the shared screen terminal 100.

The individual shared screen editing module 135 receives a move operation on a sticky displayed on the display device of the personal terminal 120, and in response to the operation, moves the sticky on the canvas (on the display device).

The shared screen display module 130 displays on the display device stickies created by the sticky module 125. Additionally, the shared screen display module 130 displays the results of processes conducted by the sticky module 125 (such as a modification process or a deletion process). In addition, the shared screen display module 130 modifies the position of stickies according to a move process conducted by the individual shared screen editing module 135. The shared screen display module 130 may also receive what is being displayed on the display device of the shared screen terminal 100, and display the received data on the display device of the personal terminal 120.

The shared screen terminal 100, the personal terminal 120, and the electronic sticky control device 150 are interconnected via a communication link. There may also be multiple personal terminals 120.

The electronic sticky control device 150 transmits the results of grouping by individual personal terminals 120 to the shared screen terminal 100, and controls the display on the display device of the shared screen terminal 100.

The terminal management module 155 is connected to the sticky/group information management module 160, the sticky-to-sticky distance calculation module 165, and the group determination module 175. The terminal management module 155 manages the shared screen terminal 100 and the personal terminal 120. For example, the terminal management module 155 detects operations, processes, and the like conducted on the shared screen terminal 100 and the personal terminal 120, which are distinguished between the shared screen terminal 100 and other than the shared screen terminal 100. In particular, the terminal management module 155 detects if a sticky grouping is conducted, and on which personal terminal 120.

The sticky/group information management module 160 is connected to the terminal management module 155, the sticky-to-sticky distance calculation module 165, and the group determination module 175. When an operation of cancelling a group selection is performed on a representative object, the sticky/group information management module 160 controls the stickies constituting the representative object to be displayed at a location corresponding to the position of the representative object. Herein, “cancelling a group selection” refers to cancelling a grouping by selecting a representative object, which is a process result of a grouping selected by another personal terminal 120 (a personal terminal 120 other than the personal terminal 120 in question; may also include the shared screen terminal 100). Specifically, the stickies constituting the representative object are displayed on the shared screen terminal 100 (or the personal terminal 120) in question. Note that cancellation may be executed by a user operation (such as by selecting the object, for example), or be executed when a predetermined condition is satisfied (such as when a predetermined time elapses after displaying the representative object, for example).

In addition, for a representative object that has received an operation cancelling a group selection, if at least one duplicate exists between the multiple stickies constituting the representative object and multiple stickies not in the representative object that exist in a predetermined relationship, the sticky/group information management module 160 controls the display format of each duplicate sticky to indicate the duplication. The above corresponds to the pattern in which a certain sticky is duplicated and adopted into multiple groups. In other words, when an operation of cancelling a group selection is performed on a representative object, the multiple stickies constituting the representative object are made to be displayed, but at this point, these multiple stickies may also be included in another group, and thus are duplicated and adopted into multiple groups. Herein, “multiple stickies in a predetermined relationship” refers to (1) multiple stickies within a predetermined range (distance), (2) multiple stickies in a relationship as a result of being explicitly selected in a group by a user (the group selection may be cancelled already, or the group selection may not be cancelled yet), and the like.

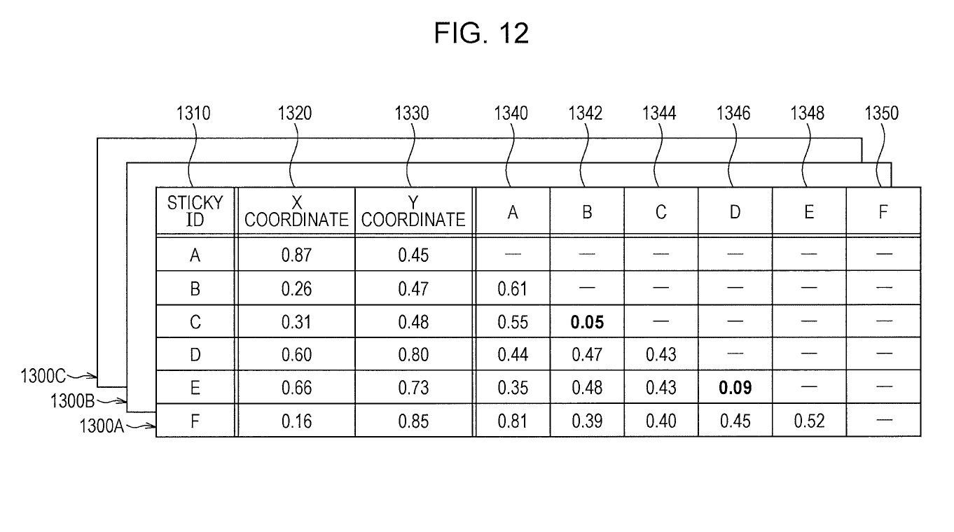

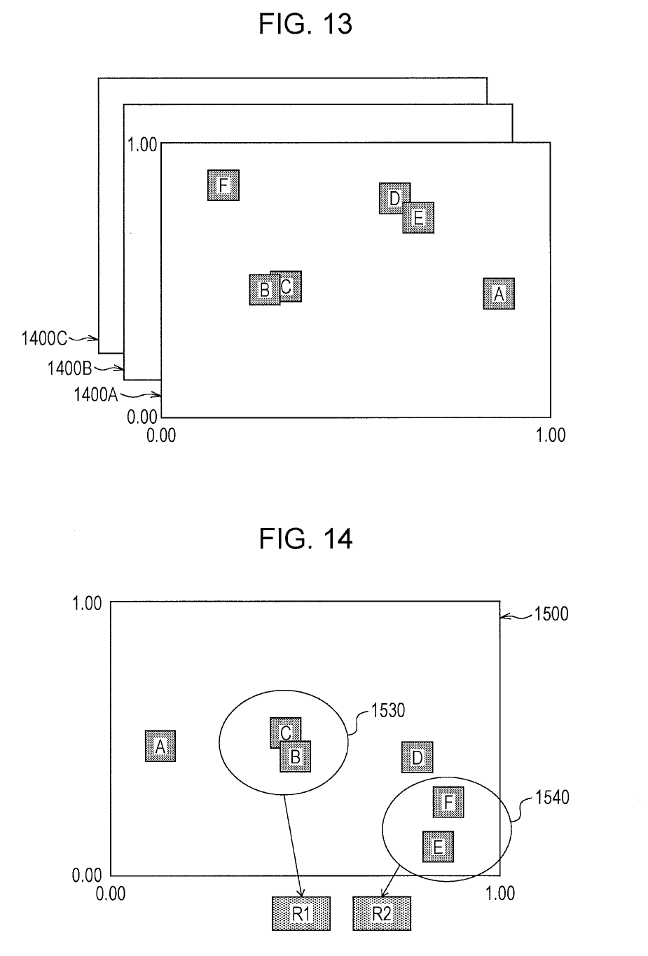

The sticky-to-sticky distance calculation module 165 is connected to the terminal management module 155, the sticky/group information management module 160, and the group determination module 175. The sticky-to-sticky distance calculation module 165 computes the distance between stickies being displayed on the display device of the shared screen terminal 100 or the personal terminal 120. The distance used herein may be the Euclidean distance, for example. However, this distance is the distance on the shared canvas, and not the distance on the display device. This is because the size of the display device differs depending on the shared screen terminal 100 or personal terminal 120. A specific example will be discussed later using the examples in FIGS. 12 and 13.

The terminal group difference determination module 170 is connected to the group determination module 175. On the basis of group information for each personal terminal 120 determined on the basis of sticky positions edited on each personal terminal 120, the terminal group difference determination module 170 determines the difference between the state of stickies (such as the state of groups) on the display device of the shared screen terminal 100, and the state of stickies (such as the state of groups) on the display device of the personal terminal 120, and decides a method of updating the display on the display device of the shared screen terminal 100. To update the grouping results from multiple personal terminals 120, it is sufficient to make a determination in n-dimensional space corresponding to the number of personal terminals 120 (n).

The group determination module 175 is connected to the terminal management module 155, the sticky/group information management module 160, the sticky-to-sticky distance calculation module 165, and the terminal group difference determination module 170. The group determination module 175 receives instructions related to the selection of a group from the shared screen terminal 100 or the personal terminal 120 with respect to multiple stickies displayed on the display device of the shared screen terminal 100. Subsequently, the group determination module 175 generates a single representative object from the multiple stickies selected as a group. Next, the group determination module 175 controls the multiple stickies selected as a group and the representative object to be displayed on the display device of the shared screen terminal 100. Herein, a “representative object” refers to something that indicates the result of a grouping process, and it is sufficient for the format of the representative object to be distinguishable from a sticky. For example, a representative object may be distinguished by color, shape, pattern, title string (a character string indicating that the object is a representative object), blinking, degree of transparency, or a combination thereof. Furthermore, a representative object may be displayed to distinguish which user performed the grouping. Also, “multiple stickies selected as a group” refers to a collection of stickies to display when an operation of “cancelling a group selection” is performed on the representative object as discussed earlier, and means the “stickies constituting the representative object”. Also, the stickies constituting the may be displayed at reduced size inside the representative object as one format of the representative object.

As another example, the representative object may also be displayed every time a group selection is received from the personal terminal 120. For this purpose, the group determination module 175 may also receive the selection of a group for multiple objects from a communicably connected personal terminal 120. Subsequently, a single representative object may be generated every time a selection of a group is received. Next, every time a representative object is generated, the representative object and the stickies selected as a group may be displayed on the display device of the shared screen terminal 100.

In addition, as a result of a move operation being performed on at least one sticky, the group determination module 175 may receive the destination position of the sticky and the stickies in a predetermined position relationship as multiple stickies selected as a group. After the sticky move operation, the stickies near the moved sticky may also be grouped.

The selection of a group includes the following, for example.

(A1) When multiple stickies are judged to be in a predetermined relationship as a result of a sticky displayed on a personal terminal 120 possessed by a user who is a participant being moved by a participant operation, the multiple stickies satisfying the relationship are treated as a selection of a group. In this case, the predetermined relationship refers to cases such as when the distances between stickies are in a predetermined relationship (specifically, a relationship in which the distances between stickies are less than, or less than or equal to, a predetermined threshold), or when the positions of stickies are in a predetermined relationship (specifically, a relationship in which the density of stickies is greater than, or equal to or greater than, a predetermined threshold, a relationship in which the stickies are arranged at a predetermined spacing, or a relationship in which the outer shape of a cluster of stickies (for example, a relationship in which the density of stickies is greater than, or equal to or greater than, a predetermined threshold) forms an elliptical shape. Note that in (A1), factors other than distance (space) may also be used to make the grouping judgment, such as the attributes of a sticky, the creation time of a sticky, or some combination thereof.

(A2) When multiple stickies are judged to be in a predetermined relationship as a result of multiple stickies desired for grouping being selected by an operation of a user who is a participant, the multiple stickies satisfying the relationship are treated as a selection of a group. The case of receiving a selection instruction from an operator means the case of storing instruction information, in which the stickies storing the instruction information exist in a predetermined relationship. For example, in grouping mode (a processing system), stickies selected by a user operation may be treated as objects to be grouped, stickies moved to a selected area may be treated as objects to be grouped, or an area such as an ellipse may be moved, enlarged, reduced, or the like, and stickies enclosed by that area may be treated as objects to be grouped. In (A2), the user's intent to perform grouping is explicit.

Additionally, the mode may also be switched between (A1) and (A2). Furthermore, in the case of (A1), a mode that conducts an automatic grouping recognition process and a mode that does not conduct an automatic grouping recognition process may be prepared. Additionally, a representative object may be displayed at the timing of switching modes. Note that operation is unaffected even when a new sticky is created (pasted).

Regarding independent operations performed on stickies (temporally and spatially independent) on two or more information processing devices (a combination of the shared screen terminal 100 and the personal terminal 120, or multiple personal terminals 120), the electronic sticky control device 150 recognizes multiple stickies whose sticky-to-sticky relationship reaches a predetermined condition as being respective temporary groups.

When updating a shared screen (such as the screen of the shared screen terminal 100) with independent work results, the stickies are left unchanged on the shared screen, and a representative object indicating a process result of grouping from elsewhere is displayed.

Note that in the present exemplary embodiment, not all differences in spatial arrangement are resolved. Also, in order to ensure freedom of spatial arrangement, a meaningful group is extracted as a collection of stickies, and that meaning is displayed as a representative object. The electronic sticky control device 150 is that which supports grouping work during sticky operations.

Note that, depending on the creation position, update source, or update destination of a sticky included in a group, when an instruction cancelling a group selection (an operation such as the selection of a representative object) is received, the display is updated (the group is unpacked) with the process result of grouping on another device. Additionally, the positions of stickies when unpacking a group are controlled and displayed on the basis of the positions of existing stickies.

In addition, a grouping work history is saved for each personal terminal 120, and may be applied to not only the shared screen of the shared screen terminal 100, but also to a merge process of merging personal work with other personal work.

Note that the predetermined condition is decided according to factors such as device differences between the shared screen terminal 100 and the personal terminal 120, difference in work content, and differences in the number of stickies.

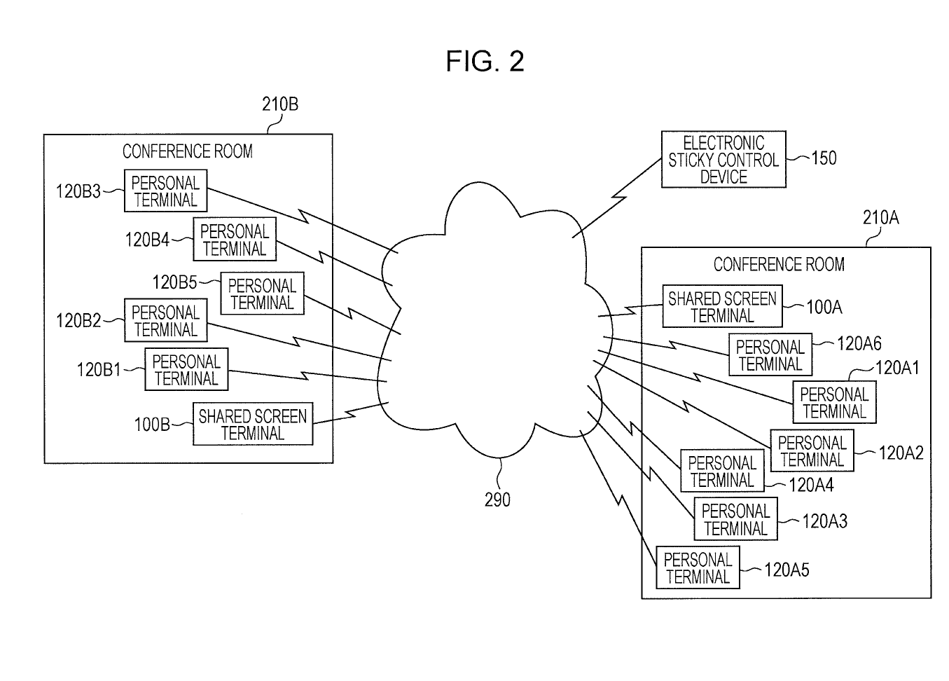

FIG. 2 is an explanatory diagram illustrating an exemplary system configuration utilizing an exemplary embodiment.

In a conference room 210A, a shared screen terminal 100A is installed, and respective users possess a personal terminal 120A1, a personal terminal 120A2, a personal terminal 120A3, a personal terminal 120A4, a personal terminal 120A5, and a personal terminal 120A6.

Similarly, in a conference room 210B, a shared screen terminal 100B is installed, and respective users possess a personal terminal 120B1, a personal terminal 120B2, a personal terminal 120B3, a personal terminal 120B4, and a personal terminal 120B5.

The shared screen terminals 100, the personal terminals 120, and the electronic sticky control device 150 are interconnected via a communication link 290. The communication link 290 may be wireless, wired, or a combination of the two, and may use a network such as the Internet or an intranet as a communication infrastructure, for example.

The functions of the electronic sticky control device 150 may also be provided to the shared screen terminals 100 and the personal terminals 120 in each of the conference rooms 210 as a cloud service.

For example, when a discussion or the like using stickies takes place in each conference room 210, the facilitator uses the shared screen terminal 100 and each user who is a participant uses the personal terminal 120 to perform operations such as creating and grouping stickies. The display device of the shared screen terminal 100 is updated with the results of the operations.

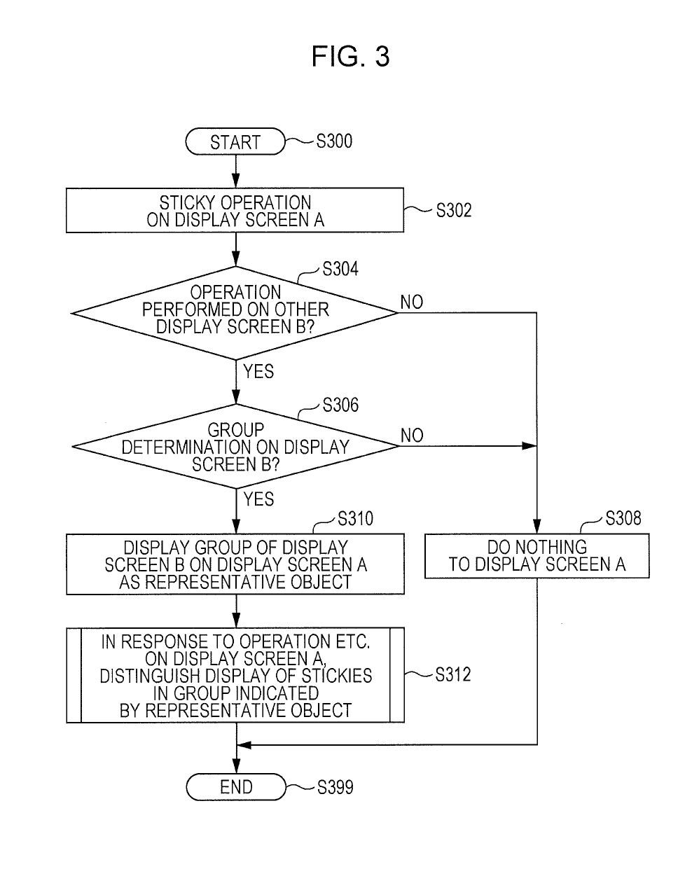

FIG. 3 is a flowchart illustrating an exemplary process according to the exemplary embodiment. In the following, the display screen A refers to the screen on the display device of any of the shared screen terminal 100 or the personal terminal 120, while the display screen B refers to the screen on the display device of any of the shared screen terminal 100 or the personal terminal 120 other than the display screen A. Since there may be multiple personal terminals 120, the display screen A may be the display screen on a certain personal terminal 120 (the personal terminal 120 of a user A), while the display screen B may be the display screen on a personal terminal 120 other than the personal terminal 120 of the display screen A (the personal terminal 120 of a user B).

In step S302, the user A performs a sticky operation on the display screen A.

In step S304, it is judged whether or not the user B performed an operation on the other display screen B, and if so, the process proceeds to step S306. Otherwise, the process proceeds to step S308.

In step S306, it is determined whether or not a grouping occurred on the display screen B, and if so, the process proceeds to step S310. Otherwise, the process proceeds to step S308.

In step S308, nothing is done to the display screen A.

In step S310, the group from the display screen B is displayed on the display screen A as a representative object.

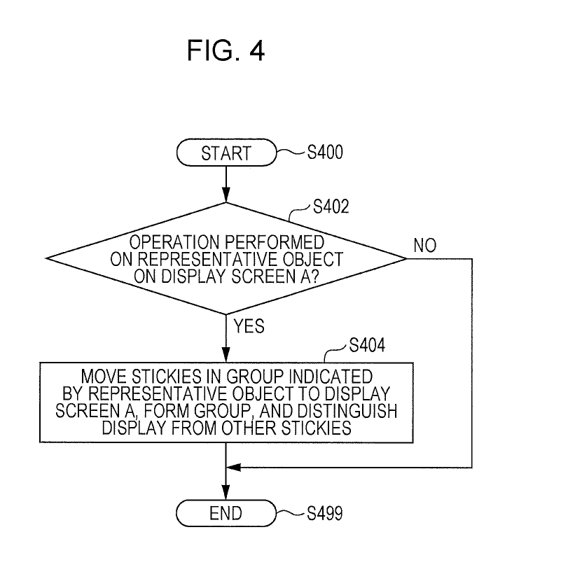

In step S312, in response to an operation or the like on the display screen A, the display is distinguished for stickies in the group indicated by the representative object. The process in step S312 will be described with reference to FIGS. 4 to 11.

FIG. 4 is a flowchart illustrating an exemplary process according to the exemplary embodiment.

In step S402, it is judged whether or not an operation was performed on the representative object on the display screen A, and if so, the process proceeds to step S404. Otherwise, the process ends (step S499).

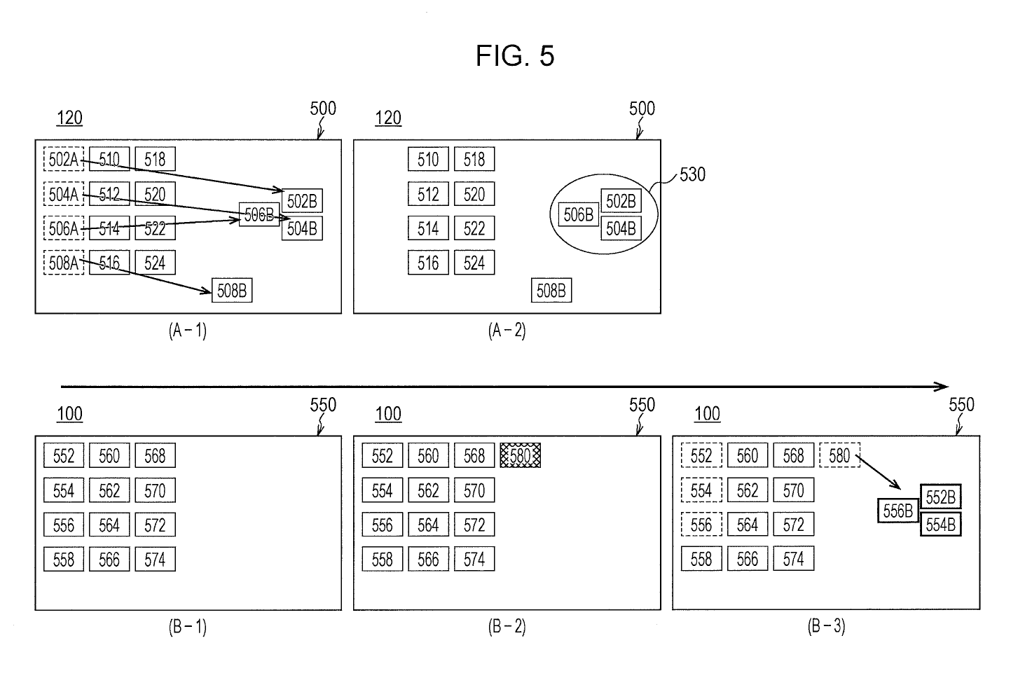

In step S404, the stickies in the group indicated by the representative object are moved on the display screen A, a group is formed, and the display of the stickies is distinguished from other stickies. A specific description will be given using the example of FIG. 5.

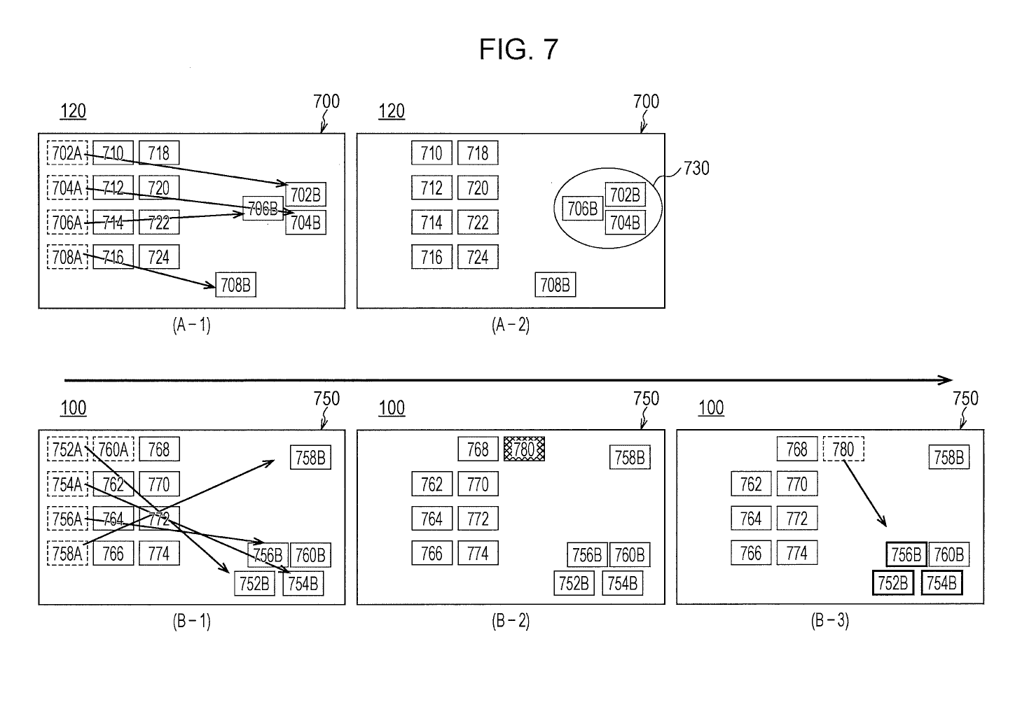

FIG. 5 is an explanatory diagram illustrating exemplary processing according to the exemplary embodiment. The upper part illustrates example displays of a screen 500 on the personal terminal 120, while the lower part illustrates example displays of a screen 550 on the shared screen terminal 100. The screen displays are arranged chronologically from left to right. This applies similarly the examples in FIGS. 7, 9, and 10 below.

(B-1) For example, 12 stickies such as a sticky 552 and a stickies 554 are being displayed on the screen 550 of the shared screen terminal 100. Meanwhile, 12 stickies such as a sticky 502 and a sticky 504 are also being displayed on the screen 500 of the personal terminal 120 in the same way as (B-1). Obviously, the same objects as (B-1) are being displayed, and the position relationships are the same. Note that the stickies on the screen 500 are labelled from 502 to 524 whereas the stickies on the screen 550 are labeled from 552 to 574, but the sticky 502 is the same as the sticky 552, and so on. This applies similarly the examples in FIGS. 7, 9, and 10 below.

(A-1) On the personal terminal 120, stickies are moved on the screen 500 according to operations by a user who is a participant. For example, a move is performed from the position of the sticky 502A to the position of the sticky 502B and so on. At this point, the sticky 502, the sticky 504, the sticky 506, and the sticky 508 are moved, but the sticky 502, the sticky 504, and the sticky 506 are moved with the intention of forming a single group. In other words, in some cases, the user attempts to classify stickies by changing the positions of the stickies on the screen 500 of the personal terminal 120. In the case of an operation according to the present exemplary embodiment, the user thinking to put the sticky 502, the sticky 504, and the sticky 506 into a single group performs an operation of moving these stickies so that the distance between the stickies becomes a prescribed distance or less. On the other hand, even though the sticky 508 is also moved, the sticky 508 is moved farther away from the other stickies.

(A-2) Stickies whose distance from other stickies is a predetermined threshold or less are recognized as a group. At this point, distance is computed for stickies that have been moved. For example, the sticky 502, the sticky 504, and the sticky 506 are recognized as a group 530. Note that, as discussed earlier, a grouping process may also be conducted according to a user operation.

(B-2) On the screen 550 (shared screen) of the shared screen terminal 100, the group selected by the personal terminal 120 is received and displayed as a single representative object 580 (herein, a sticky object with a different color from normal stickies). Note that the representative object 580 may be displayed at any location, insofar as the location is other than the position of a sticky already being displayed.

(B-3) When the representative object 580 is selected by a user operation, the group (collection of stickies) that was being indicated by the representative object 580 is unpacked and displayed. For example, as illustrated in the example of (B-3), the sticky 552, the sticky 554, and the sticky 556 are moved and displayed at a similar position as the display (A-2) on the personal terminal 120 that conducting the grouping process (the position of the sticky 502B, the sticky 504B, and the sticky 506B). At this point, one conceivable method of displaying stickies at a similar position is a method of moving and displaying the sticky 552, the sticky 554, and the sticky 556 on the screen 550 of the shared screen terminal at a position expressed by the same XY coordinates as on the screen 500 of the personal terminal 120. As another method, the sticky 552, the sticky 554, and the sticky 556 may be moved and displayed on the screen 550 so that the relative position relationships among the three stickies of the sticky 552, the sticky 554, and the sticky 556 on the screen 550 of the shared screen terminal 100 become similar relative position relationships to the sticky 502B, the sticky 504B, and the sticky 506B on the screen 500 of the personal terminal 120.

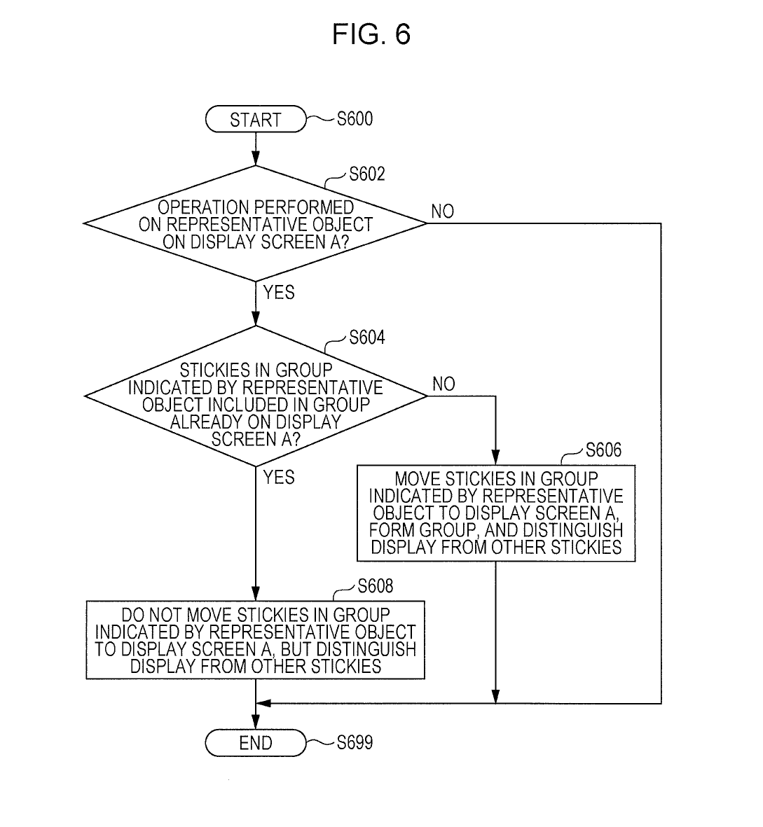

FIG. 6 is a flowchart illustrating an exemplary process according to the exemplary embodiment. The present exemplary embodiment anticipates the case in which a grouping operation performed by a user on the terminal A including the display screen A is performed in parallel with a grouping operation performed by a user on the other terminal B. When the terminal B is operated and multiple stickies are grouped, a representative object is displayed is displayed on the display screen A of the terminal A that detects the grouping. Also, when an operation of cancelling a grouping is performed on the representative object on the display screen A by an operation performed in parallel on the terminal A, the multiple stickies included in the group that was being indicated by the representative object are displayed according to the method described below in the case in which the multiple stickies belonged to a separate group as a result of an operation by the user operating the display screen A.

In step S602, it is judged whether or not an operation was performed on the representative object on the display screen A, and if so, the process proceeds to step S604. Otherwise, the process ends (step S699).

In step S604, it is judged whether or not the stickies in the group indicated by the representative object are included in a group already on the display screen A, and if so, the process proceeds to step S608. Otherwise, the process proceeds to step S606.

In step S606, the stickies in the group indicated by the representative object are moved on the display screen A, a group is formed, and the display of the stickies is distinguished from other stickies.

In step S608, the stickies are not moved on the display screen A, and the display of stickies in the group indicated by the representative object is distinguished from other stickies. A specific description will be given using the example of FIG. 7.

FIG. 7 is an explanatory diagram illustrating exemplary processing according to the exemplary embodiment.

(A-1) On the personal terminal 120, stickies are moved on the screen 500 according to operations by a user who is a participant. This is similar to the process in (A-1) of FIG. 5.

(A-2) Stickies whose distance from other stickies is a predetermined threshold or less are recognized as a group. This is similar to the process in (A-2) of FIG. 5.

(B-1) In parallel with the grouping process on the personal terminal 120, stickies are also moved on the screen 750 of the shared screen terminal 100, according to an operation by a user who is the facilitator. This is similar to the process in (A-1) of FIG. 7. However, since a grouping process is being conducted by another user, different group configurations may occur. In the case of this example, the collection of stickies in the group indicated by the representative object are included in the group on the shared screen terminal 100. In other words, the sticky 752, the sticky 754, the sticky 756, and the sticky 760 are treated as a single group.

(B-2) On the screen 750 (shared screen) of the shared screen terminal 100, the group selected by the personal terminal 120 is received and displayed as a single representative object 780 (herein, a sticky object with a different color from normal stickies). This is similar to the process in (B-2) of FIG. 5.

(B-3) When the representative object 780 is selected by a user operation, the group (collection of stickies) that was being indicated by the representative object 780 is unpacked and displayed. For example, as illustrated in the example of (B-3), the sticky 752, the sticky 754, and the sticky 756 are displayed so as to indicated that a grouping process was conducted on the personal terminal 120. For example, the display is changed so that the sticky 752 and the like are enclosed in bold lines, as illustrated in (B-3). Note that the stickies are displayed at the existing positions on the screen 750 (without conducting a move process).

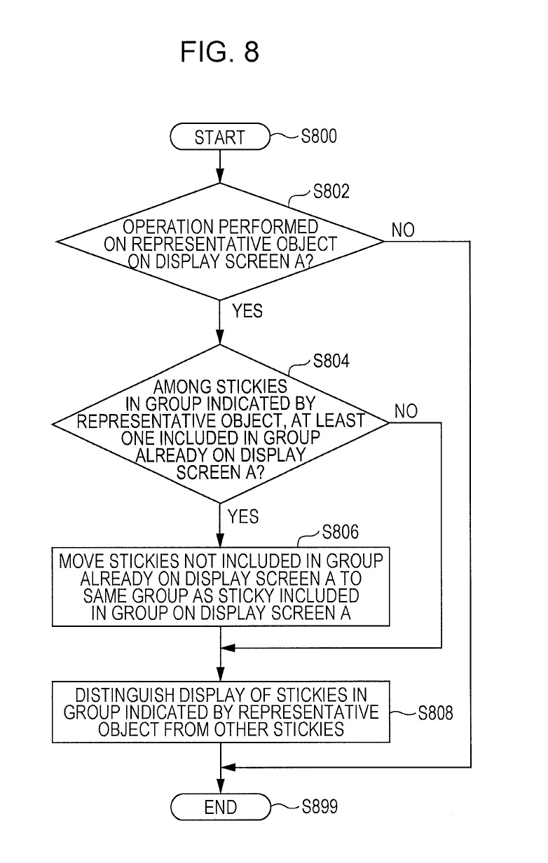

FIG. 8 is a flowchart illustrating an exemplary process according to the exemplary embodiment.

In step S802, it is judged whether or not an operation was performed on the representative object on the display screen A, and if so, the process proceeds to step S804. Otherwise, the process ends (step S899).

In step S804, it is judged whether or not, among the stickies in the group indicated by the representative object, at least one is included in a group already on the display screen A, and if so, the process proceeds to step S806. Otherwise, the process proceeds to step S808.

In step S806, a sticky not already included in a group on the display screen A is moved to the same group as the stickies included in the group on the display screen A.

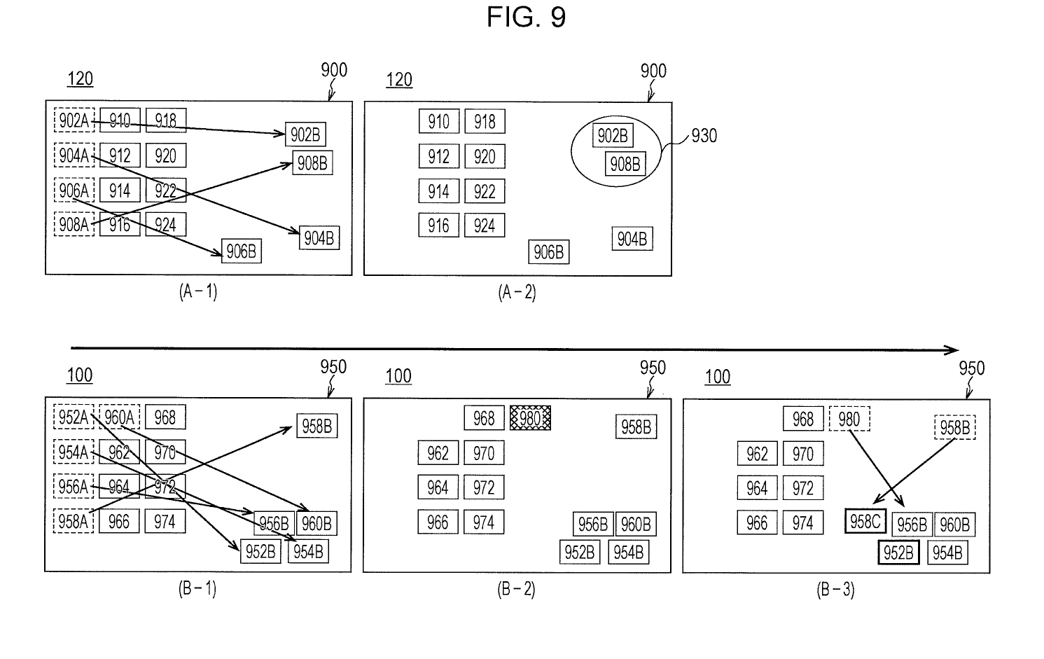

In step S808, the display of the stickies in the group indicated by the representative object is distinguished from other stickies. A specific description will be given using the example of FIG. 9.

FIG. 9 is an explanatory diagram illustrating exemplary processing according to the exemplary embodiment.

The operation illustrated in the example of FIG. 9 includes both operations illustrated in the examples of FIG. 5 (movement) and FIG. 7 (no movement), and also illustrates a case in which the movement destination is an existing group.

(A-1) On the personal terminal 120, stickies are moved on the screen 900 according to operations by a user who is a participant. This is similar to the process in (A-1) of FIG. 5. However, at this point, the sticky 902, the sticky 904, the sticky 906, and the sticky 908 are moved, but the sticky 902 and the sticky 908 are moved with the intention of forming a single group.

(A-2) Stickies whose distance from other stickies is a predetermined threshold or less are recognized as a group. This is similar to the process in (A-2) of FIG. 5. For example, the sticky 902 and the sticky 908 are recognized as a group 930.

(B-1) In parallel with the grouping process on the personal terminal 120, stickies are also moved on the screen 950 of the shared screen terminal 100, according to an operation by a user who is the facilitator. This is similar to the process in (B-1) of FIG. 7.

(B-2) On the screen 950 (shared screen) of the shared screen terminal 100, the group selected by the personal terminal 120 is received and displayed as a single representative object 980 (herein, a sticky object with a different color from normal stickies). This is similar to the process in (B-2) of FIG. 7.

(B-3) When the representative object 980 is selected by a user operation, the group (collection of stickies) that was being indicated by the representative object 980 is unpacked and displayed. This is similar to the process in (B-3) of FIG. 7.

However, the sticky which is not part of a group on the screen 950 of the shared screen terminal 100 despite being a sticky constituting part of the representative object 980 (in (B-3), the sticky 950 (corresponds to the sticky 908 in (A-2))) is moved to a position near the grouped stickies. In (B-3), a move is performed from the position of the sticky 958B to the position of the sticky 958C adjacent to the sticky 952B.

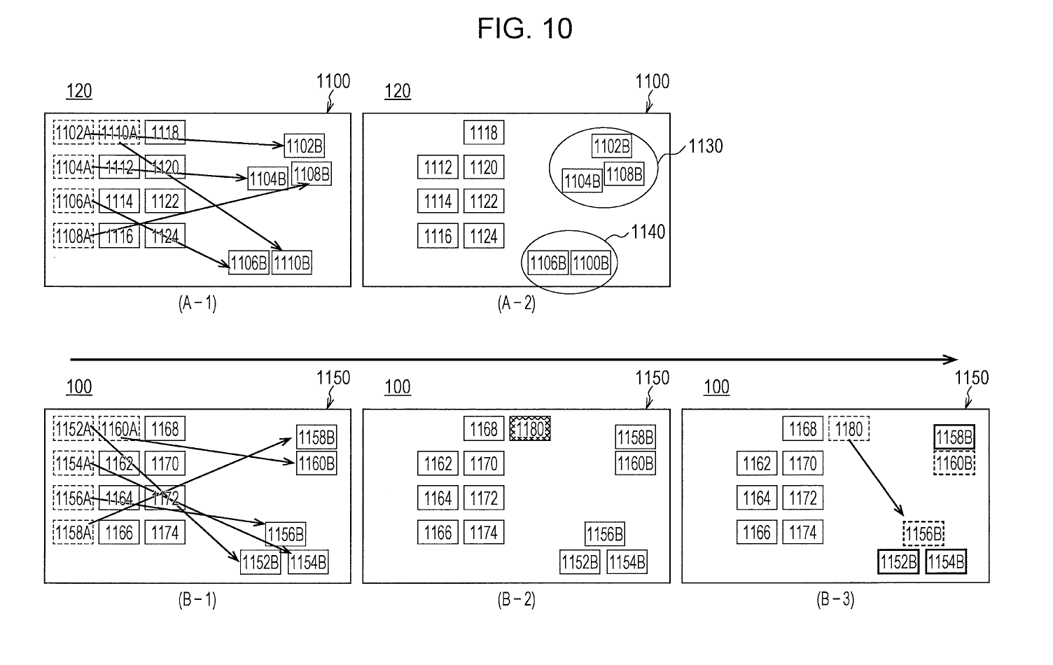

FIG. 10 is an explanatory diagram illustrating an exemplary process according to the exemplary embodiment.

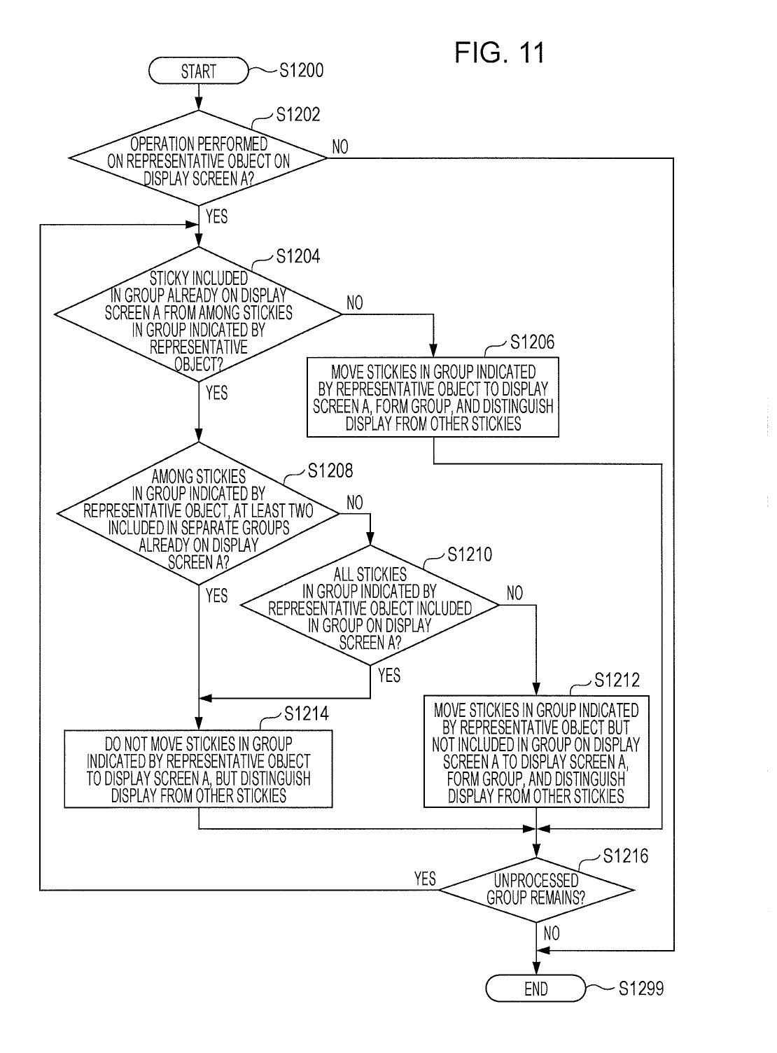

The operation illustrated in the example of FIG. 10 is an illustration of the case in which movement according to the operation illustrated in the example of FIG. 9 is obstructed by interference. Furthermore, the example of FIG. 10 is also the case in which the representative object includes multiple groups. Note that the process illustrated in the example of FIG. 10 is conducted according to the flowchart illustrated in the example of FIG. 11.

(A-1) On the personal terminal 120, stickies are moved by the shared screen display module 110 according to operations by a user who is a participant. This is similar to the process in (A-1) of FIG. 5. However, at this point, the sticky 1102, the sticky 1104, the sticky 1106, the sticky 1108, and the sticky 1110 are moved, but the sticky 1102, the sticky 1104, and the sticky 1108 are moved with the intention of forming a group, while the sticky 1106 and the sticky 1110 are moved with the intention of forming another group.

(A-2) Stickies whose distance from other stickies is a predetermined threshold or less are recognized as a group. This is similar to the process in (A-2) of FIG. 5.

(B-1) In parallel with the grouping process on the personal terminal 120, stickies are also moved on the screen 1150 of the shared screen terminal 100, according to an operation by a user who is the facilitator. This is similar to the process in (B-1) of FIG. 7. However, at this point, the sticky 1152, the sticky 1154, the sticky 1156, the sticky 1158, and the sticky 1160 are moved, but the sticky 1158 and the sticky 1160 are moved with the intention of forming a group, while the sticky 1152, the sticky 1154, and the sticky 1156 are moved with the intention of forming another group. Grouping that is different from the grouping process on the personal terminal 120 (the grouping process in (A-2)) is conducted.

(B-2) On the screen 1150 (shared screen) of the shared screen terminal 100, the group selected by the personal terminal 120 is received and displayed as a single representative object 1180 (herein, a sticky object with a different color from normal stickies). This is similar to the process in (B-2) of FIG. 7. Note that the representative object 1180 is a reflection of the two grouping process results of the group 1130 and the 1140 (grouping process results on one personal terminal 120).

(B-3) When the representative object 1180 is selected by a user operation, the group (collection of stickies) that was being indicated by the representative object 1180 is unpacked and displayed. This is similar to the process in (B-3) of FIG. 7.

Particularly, stickies grouped on the screen 1150 of the shared screen terminal 100 despite being stickies constituting part of the representative object 1180 (the case in which the stickies to be grouped are the same, but are in different groups, also called interference) are displayed in the same was as (B-3) of FIG. 7. In other words, unlike (B-3) of FIG. 9, the stickies are not moved, but displayed in a format indicating that the stickies constitute the same group (in (B-3), the group of the sticky 1152, the sticky 1154, and the sticky 1158 enclosed in bold lines which indicate the group 1130, and the group of the sticky 1156 and the sticky 1160 enclosed in dashed lines which indicate the group 1140).

FIG. 11 is a flowchart illustrating an exemplary process according to the exemplary embodiment. FIG. 11 combines the process examples in FIGS. 4, 6, and 8 while branching according to successive judgments. In other words, the process in step S1206 corresponds to the process of FIG. 4, the process in step S1214 corresponds to the process in FIG. 6, and the process in step S1212 corresponds to the process in FIG. 8. Note that the case of Yes in step S1208 corresponds to the process of FIG. 6.

In step S1202, it is judged whether or not an operation was performed on the representative object on the display screen A, and if so, the process proceeds to step S1204. Otherwise, the process ends (step S1299).

In step S1204, it is judged whether or not a sticky included in a group already on the display screen A exists from among the stickies in the group indicated by the representative object, and if so, the process proceeds to step S1208. Otherwise, the process proceeds to step S1206.

In step S1206, the stickies in the group indicated by the representative object are moved on the display screen A, a group is formed, and the display of the stickies is distinguished from other stickies.

In step S1208, it is judged whether or not, among the stickies in the same group indicated by the representative object, at least two are respectively included in separate groups already on the display screen A, and if so, the process proceeds to step S1214. Otherwise, the process proceeds to step S1210. A “Yes” judgment in step S1208 means that there are multiple groups on the display screen A, and the stickies within the group indicated by the representative object exist in multiple groups on the display screen A. For example, in some cases, there may be a group G and a group H as the groups on the display screen A, a sticky x and a sticky y as the stickies within the group indicated by the representative object, and on the display screen A, the sticky x exists in the group G while the sticky y exists in the group H.

In step S1210, it is judged whether or not the stickies in the group indicated by the representative object are all included within a group on the display screen A, and if so, the process proceeds to step S1214. Otherwise, the process proceeds to step S1212.

In step S1212, the stickies in the group indicated by the representative object but not included in a group on the display screen A are moved to a group on the display screen A, a group is formed, and the display of the stickies is distinguished from other stickies.

In step S1214, the stickies are not moved on the display screen A, and the display of stickies in the group indicated by the representative object is distinguished from other stickies.

In step S1216, it is judged whether or not an unprocessed group remains, and if so, the process returns to step S1204. Otherwise the process ends (step S1299).

FIG. 12 is an explanatory diagram illustrating an exemplary data structure of a sticky-to-sticky distance table 1300. A sticky-to-sticky distance table 1300 is created for each of the shared screen terminal 100 and the personal terminal 120 (if there are multiple personal terminals 120, a table is created for each personal terminal 120). The sticky-to-sticky distance table 1300 indicates the respective coordinate positions of stickies on the canvas, and the distances between stickies.

The sticky-to-sticky distance table 1300A includes a sticky ID field 1310, an X coordinate field 1320, a Y coordinate field 1330, a sticky ID: A field 1340, a sticky ID: B field 1342, a sticky ID: C field 1344, a sticky ID: D field 1346, a sticky ID: E field 1348, and a sticky ID: F field 1350.

The sticky ID field 1310 stores information (a sticky identification (ID)) for uniquely identifying a sticky in the present exemplary embodiment. The X coordinate field 1320 stores the X coordinate. The Y coordinate field 1330 stores the Y coordinate. The sticky ID: A field 1340 stores distances to the sticky ID: A. The sticky ID: B field 1342 stores distances to the sticky ID: B. The sticky ID: C field 1344 stores distances to the sticky ID: C. The sticky ID: D field 1346 stores distances to the sticky ID: D. The sticky ID: E field 1348 stores distances to the sticky ID: E. The sticky ID: F field 1350 stores distances to the sticky ID: F. In other words, the distance between each of the stickies (herein, the Euclidean distance) is stored.

FIG. 13 is an explanatory diagram illustrating an example arrangement of stickies A to F on a screen 1400. The screen 1400 represents the screen for each of the shared screen terminal 100 and the personal terminal 120 (if there are multiple personal terminals 120, the screen for each personal terminal 120). Provided that the lower-left is the origin (0, 0), and a coordinate space is defined by an x-axis (rightward direction) and a y-axis (upward direction) ranging from 0 to 1, positions and distances in this coordinate space are expressed by the sticky-to-sticky distance table 1300 illustrated in the example of FIG. 12.

For example, in the case of setting the threshold for grouping determination to 0.15, among the stickies A to F, the distance between the stickies B-C and between the stickies D-E is less than or equal to (or simply less than) the threshold, and thus these stickies are respectively treated as stickies to be grouped.

These determinations are carried out in units of the screens on which work is performed. Note that these determinations may or may not be carried out in units of users.

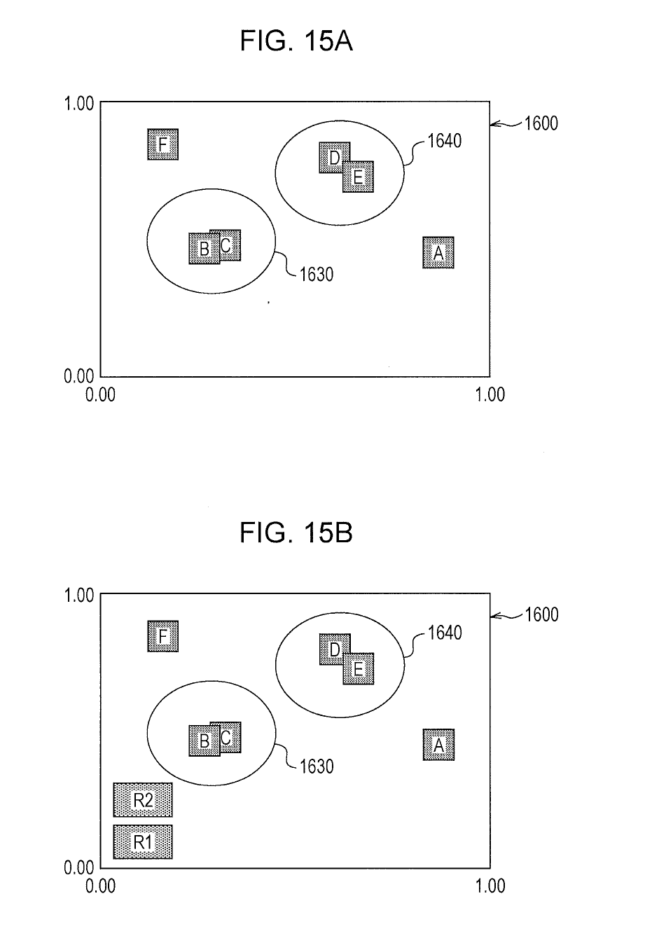

FIGS. 14, 15A, and 15B are explanatory diagrams illustrating exemplary processes according to the exemplary embodiment. The update of a screen to reflect the results of grouping processes by multiple people will be described.

FIGS. 14, 15A, and 15B illustrate the case of updating the screen 1600 of a user L to reflect the result of a grouping determination for the user R (the result on the screen 1500 illustrated in the example of FIG. 14). As illustrated in the example of FIG. 14, in response to an operation by the user R, the stickies B-C and the stickies E-F are determined to be a group 1530 and a group 1540, respectively, and thus are treated as a representative object R1 and a representative object R2, respectively. As a result of a grouping determination for the user L, the stickies B-C and the stickies D-E are determined to a group 1630 and a group 1640, respectively, like the result on the screen 1600 illustrated in the example of FIG. 15A. Subsequently, at the time when the operation by the user R ends (or the time when the operation by the user L ends), the screen 1600 on the user L side is updated to reflect the representative objects R1 and R2 that correspond to the group 1530 and the group 1540, respectively, as illustrated in the example of FIG. 15B.

Note that merging of groups between personal terminals 120 presupposes asynchronous work. For example, when there is no shared screen of the shared screen terminal 100, and each user moves stickies on a personal terminal 120, at the timing when a new user joins, the representative objects from the grouping results of the other users are displayed, and the new user is able to perform work after tracing the previous work as appropriate. Conversely, a user may also perform grouping work without being affected by others, and representative objects may be displayed at the timing when the work is merged with results from others.

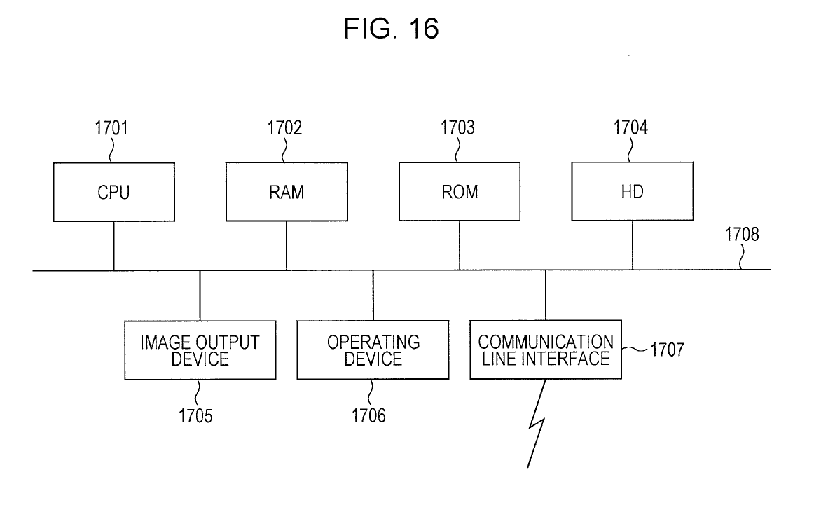

Note that a hardware configuration of a computer executing a program that acts as the present exemplary embodiment (shared screen terminal 100, personal terminal 120, electronic sticky control device 150) is a general computer as illustrated by the example of FIG. 16, and specifically is a computer or the like that may be a personal computer or a server. In other words, as a specific example, a CPU 1701 is used as a processing unit (computational unit), while RAM 1702, ROM 1703, and an HD 1704 are used as storage devices. For the HD 1704, a hard disk or a solid-state drive (SSD) may be used, for example. The computer is made up of the CPU 1701 that executes programs such as the sticky module 105, the shared screen display module 110, the shared screen editing module 115, the sticky module 125, the shared screen display module 130, the individual shared screen editing module 135, the terminal management module 155, the sticky/group information management module 160, the sticky-to-sticky distance calculation module 165, the terminal group difference determination module 170, and the group determination module 175, the RAM 1702 that stores such programs and data, the ROM 1703 that stores programs and the like for activating the computer, the HD 1704 which is an auxiliary storage device (and may also be flash memory or the like), a receiving device 1706 that receives data on the basis of user operations with respect to a keyboard, mouse, touch panel, or the like, an image output device 1705 such as a CRT or liquid crystal display, a communication link interface 1707 such as a network interface card for connecting to a communication network, and a bus 1708 for joining and exchanging data with the above components. Multiple such computers may also be connected to each other by a network.

Of the foregoing exemplary embodiments, for those made up of a computer program, software in the form of a computer program is made to be read into a system with the above hardware configuration, and the foregoing exemplary embodiments are realized by the cooperative action of the software and hardware resources.

Note that the hardware configuration illustrated in FIG. 16 illustrates a single exemplary configuration, and that the exemplary embodiment is not limited to the configuration illustrated in FIG. 16 insofar as the configuration still enables execution of the modules described in the exemplary embodiment. For example, some modules may also be realized with special-purpose hardware (such as an application-specific integrated circuit (ASIC), for example), and some modules may be configured to reside within an external system and be connected via a communication link. Furthermore, it may also be configured such that multiple instances of the system illustrated in FIG. 16 are connected to each other by a communication link and operate in conjunction with each other. Additionally, besides a personal computer in particular, an exemplary embodiment may also be incorporated into a device such as an mobile information/communication device (including devices such as a mobile phone, a smartphone, mobile equipment, and a wearable computer), information appliance, photocopier, fax machine, scanner, printer, or multi-function device (that is, an image processing device having two or more from among scanning, printing, copying, and faxing functions).

The foregoing exemplary embodiment illustrates an example of the electronic sticky control device 150 conducting the processes for grouping and the like, but the personal terminal 120 may also be configured to conduct similar processes. In other words, the personal terminal 120 may also conduct group selection and substitution with a representative object. Accordingly, the personal terminal 120 may also be configured as follows, for example.

The personal terminal 120 may be provided with: a communication module that communicates with the shared screen terminal 100; a second display module that displays multiple stickies; a second selection receiving module that receives an instruction related to a selection of a group with respect to multiple stickies displayed on the second display module; a second object generation module that generates a single representative object from the multiple stickies selected as a group by the second selection receiving module; and an instruction module that instructs a first display module provided in the shared screen terminal 100 to display the representative object.

For example, regarding the group selections (A1) and (A2) discussed earlier, in the foregoing exemplary embodiment, the electronic sticky control device 150 (group determination module 175) made the judgment, but the personal terminal 120 may also judge the existence of a group selection. For example, when the personal terminal 120 conducts the selection and judgment of a group, the electronic sticky control device 150 receives the selection result. Conversely, when the judgment of grouping is conducted on the electronic sticky control device 150 side, the electronic sticky control device 150 receives operation information about an operation on stickies displayed on the personal terminal 120, and a grouping process is conducted on the electronic sticky control device 150 side.

Also, when a representative object is displayed, the stickies constituting the representative object are displayed unchanged on the display device of the shared screen terminal 100. For this reason, the stickies constituting the representative object have two display positions (the position of the unchanged sticky, and the position of the representative object). However, since the position where the representative object is first displayed does not have particular meaning, having two positions immediately after being displayed is not itself a problem.

Note that the displayed stickies may also be moved to the position of the representative object. When a sticky is moved and the representative object is not unpacked, a display is presented to indicate that the sticky is included in the representative object. Obviously, since the sticky is moved, the display of the sticky at the original position is deleted.

Note that the described program may be provided stored in a recording medium, but the program may also be provided via a communication medium. In this case, a computer-readable recording medium storing a program, for example, may also be taken to be an exemplary embodiment of the present invention with respect to the described program.

A “computer-readable recording medium storing a program” refers to a computer-readable recording medium upon which a program is recorded, and which is used in order to install, execute, and distribute the program, for example.

The recording medium may be a Digital Versatile Disc (DVD), encompassing formats such as DVD-R, DVD-RW, and DVD-RAM defined by the DVD Forum and formats such as DVD+R and DVD+RW defined by DVD+RW Alliance, a compact disc (CD), encompassing formats such as read-only memory (CD-ROM), CD Recordable (CD-R), and CD Rewritable (CD-RW), a Blu-ray Disc (registered trademark), a magneto-optical (MO) disc, a flexible disk (FD), magnetic tape, a hard disk, read-only memory (ROM), electrically erasable and programmable read-only memory (EEPROM (registered trademark)), flash memory, random access memory (RAM), or a Secure Digital (SD) memory card, for example.

In addition, all or part of the above program may also be recorded to the recording medium and saved or distributed, for example. Also, all or part of the above program may be communicated by being transmitted using a transmission medium such as a wired or wireless communication network used in a local area network (LAN), a metropolitan area network (MAN), a wide area network (WAN), an internet, an intranet, an extranet, or some combination thereof, or alternatively, by being modulated onto a carrier wave and propagated.

Furthermore, the above program may be part of another program, and may also be recorded to a recording medium together with other separate programs. The above program may also be recorded in a split manner across multiple recording media. The above program may also be recorded in a compressed, encrypted, or any other recoverable form.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A display control device comprising:
a selection receiver that receives a selection related to a selection of a group with respect to a plurality of objects displayed on a first display;
a first object generator that generates a single representative object from the plurality of objects selected as the group; and
a display controller that displays the plurality of objects selected as the group and the representative object on the first display.

2. The display control device according to claim 1, wherein
the selection receiver receives a selection of a group with respect to the plurality of objects from a communicably connected terminal,
the first object generator generates a single representative object every time the selection receiver receives a selection of a group, and
every time a representative object is generated by the first object generator, the display controller displays the representative object and the objects selected as the group on the first display.

3. The control device according to claim 1, comprising:
a selection canceller that displays objects constituting a representative object at a location depending on a position of the representative object in case of a cancellation of a group selection with respect to the representative object being received.

4. The control device according to claim 2, comprising:
a selection canceller that displays objects constituting a representative object at a location depending on a position of the representative object in case of a cancellation of a group selection with respect to the representative object being received.

5. The display control device according to claim 3, comprising:
a display format controller that, with respect to a representative object for which the selection canceller receives a cancellation of a group selection, when at least one duplicate exists between the plurality of objects constituting the representative object and a plurality of objects other than the representative object that exist in a predetermined relationship, displays the at least one duplicate object in a format indicating the duplication.

6. The display control device according to claim 4, comprising:
a display format controller that, with respect to a representative object for which the selection canceller receives a cancellation of a group selection, when at least one duplicate exists between the plurality of objects constituting the representative object and a plurality of objects other than the representative object that exist in a predetermined relationship, displays the at least one duplicate object in a format indicating the duplication.

7. The control device according to claim 1, wherein
the selection receiver receives, as a plurality of objects selected as the group, a destination position of at least one object resulting from a move operation being performed on the at least one object, and objects that exist in a predetermined position relationship with each other.

8. A communication terminal comprising:
a communication unit that communicates with a display control device;
a second display that displays a plurality of objects;
a second selection receiver that receives a selection related to a selection of a group with respect to a plurality of objects displayed on the second display;
a second object generator that generates a single representative object from the plurality of objects selected as the group by the second selection receiver; and
an instruction unit that instructs a first display provided in the display control device to display the representative object.

9. A display control method comprising:
receiving a selection related to a selection of a group with respect to a plurality of objects displayed on a first display;
generating a single representative object from the plurality of objects selected as the group; and
displaying the plurality of objects selected as the group and the representative object on the first display.
